(19) United States
(12) Patent Application Publication
(10) Pub. No.: US 2025/0236134 A1
(43) Pub. Date: Jul. 24, 2025

(54) CONTROL DEVICE AND CONTROL METHOD OF VARIABLE WHEEL

(71) Applicants: HYUNDAI MOTOR COMPANY, Seoul (KR); KIA CORPORATION, Seoul (KR)

(72) Inventors: Un Tae KIM, Suwon-si (KR); Sang Myun PARK, Seoul (KR); Gyeong Min HWANG, Hwaseong-si (KR); Jun Sik SHIN, Anyang-si (KR); Sang Hyun PARK, Seoul (KR); Jeong Min HAN, Pohang-si (KR)

(73) Assignees: HYUNDAI MOTOR COMPANY, Seoul (KR); KIA CORPORATION, Seoul (KR)

(21) Appl. No.: 18/678,336

(22) Filed: May 30, 2024

(30) Foreign Application Priority Data
Jan. 23, 2024 (KR) 10-2024-0010012

(51) Int. Cl. B60B 3/10; B60B 19/10

(52) U.S. Cl. CPC B60B 3/10; B60B 19/10; B60B 2900/1216

(57) ABSTRACT

A control device of a variable wheel may include: a receiving unit configured to receive internal driving information of a vehicle; and a controller operatively connected to the receiving unit and configured to control a flap of the variable wheel provided on each wheel of the vehicle to rotate in a first direction or a second direction, based on the internal driving information, wherein the controller may individually control a rotation direction or a rotation angle of the flap of the variable wheel.

### CROSS-REFERENCE TO RELATED APPLICATION(S)

The present application claims priority to Korean Patent Application No. 10-2024-0010012 filed on Jan. 23, 2024, the entire contents of which is incorporated herein for all purposes by this reference.

### BACKGROUND OF THE PRESENT DISCLOSURE

### Field of the Present Disclosure

The present disclosure relates to a control device and a control method of a variable wheel.

### Description of Related Art

The design of a vehicle is designed to minimize air resistance based on a vehicle aerodynamic test.

Here, vehicle aerodynamic testing is generally conducted based on actual vehicle testing in a wind tunnel.

For example, in a wind tunnel, wind is actually generated in front of the vehicle at a speed of 140 kilometers per hour (km/h), and wheels rotate while adjusting the rotation speed of the vehicle's wheels to the wind speed and air resistance applied to the vehicle is measured, thus conducting an aerodynamic test.

In the present manner, the vehicle according to the related art may be designed to minimize drag against wind blowing from the front of the vehicle, based on the results of the aerodynamic test.

Meanwhile, in an actual driving vehicle, the wind does not always blow from the front due to the influence of the vehicle's steering and surrounding air, crosswinds may occur depending on weather and driving conditions and a certain yaw angle may be formed from the front of the vehicle, thus allowing the wind to blow toward the vehicle.

In the instant case, in the case of a vehicle design optimized for wind blowing from the front, when the wind blows toward the vehicle at a certain angle rather than from the front, the drag of the vehicle may deteriorate, which may cause all-electric range (AER) performance to deteriorate.

Here, all-electric range (AER) performance may refer to a driving distance on a single charge of an electric vehicle.

Accordingly, by optimizing the aerodynamics of the vehicle in consideration of the direction of the wind acting on the vehicle and the factors affecting the direction of the wind, a technology which may improve all-electric range (AER) performance as well as fuel efficiency is required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a control device of a variable wheel which may optimize the aerodynamics of a vehicle by adjusting a direction and an angle of a flap of the variable wheel according to the driving situation.

According to an aspect of the present disclosure, a control device of a variable wheel may include: a receiving unit configured to receive internal driving information of a vehicle; and a controller operatively connected to the receiving unit and configured to control a flap of the variable wheel provided on each wheel of the vehicle to rotate in a first direction or a second direction, based on the internal driving information, wherein the controller may individually control a rotation direction or a rotation angle of the flap of the variable wheel.

The first direction may be a direction of rotation of the flap of the variable wheel to allow air to flow from an outside of the wheel to an inside thereof, and the second direction may be a direction of rotation of the flap of the variable wheel to allow air to flow from the inside of the wheel to the outside.

The internal driving information may include information on a ground clearance of the vehicle, and the controller may be configured for controlling the flap of the variable wheel by comparing the ground clearance with a predetermined reference ground clearance.

In a case in which the ground clearance is lower than the reference ground clearance, the controller may be configured for controlling the flap of the variable wheel to reduce air flow passing through the variable wheel.

In a case in which the ground clearance is higher than the reference ground clearance, the controller may be configured for controlling the flap to reduce air flow passing through the variable wheel provided on a front wheel side, and may be configured for controlling the flap of the variable wheel provided on a rear wheel side to rotate in the first direction.

The internal driving information may include information on occurrence of understeer or oversteer of the vehicle, and in a case in which understeer or oversteer occurs, the controller may be configured for controlling the flap so that air flow formed by the variable wheel provided on a front wheel side and air flow formed by the variable wheel provided on a rear wheel are formed in opposition to each other.

The controller may be configured for controlling the variable wheel provided on a right front wheel of the vehicle and the flap of the variable wheel provided on a left rear wheel of the vehicle to rotate in the same direction, and control the variable wheel provided on a left front wheel of the vehicle and the flap of the variable wheel provided on a right rear wheel of the vehicle to rotate in a same direction, and may be configured for controlling the variable wheel provided on the right front wheel and the flap of the variable wheel provided on the left rear wheel to rotate in different directions from the variable wheel provided on the left front wheel and the flap of the variable wheel provided on the right rear wheel.

The internal driving information may include lateral acceleration information and steering angle information, and the controller may be configured for controlling the flap of the variable wheel by comparing the lateral acceleration with reference lateral acceleration determined based on a steering angle of the vehicle.

The controller may be configured for controlling the variable wheel so that the flap of the variable wheel provided on a left side of a front wheel and a rear wheel of the vehicle and the flap of the variable wheel provided on a right side of the front wheel and the rear wheel rotate in different directions.

According to another aspect of the present disclosure, a control device of a variable wheel may include: a receiving unit configured to receive external driving information of a driving vehicle; and a controller operatively connected to the receiving unit and configured to control a flap of the variable wheel provided on each wheel of the vehicle to rotate in a first direction or a second direction, based on the external driving information, wherein the controller may individually control a rotation direction or rotation angle of the flap of the variable wheel.

The first direction may be a direction of rotation of the flap of the variable wheel to allow air to flow from an outside of the wheel to an inside thereof, and the second direction may be a direction of rotation of the flap of the variable wheel to allow air to flow from the inside of the wheel to the outside.

The external driving information may include relative position information of a surrounding vehicle driving close to the driving vehicle, and the controller may be configured for controlling the flap of the variable wheel by dividing a relative position into a plurality of sections, based on the relative position information of the surrounding vehicles.

The plurality of sections may be distinguished according to changes in a magnitude or a direction of force and moment acting on the driving vehicle which change depending on a relative position of the driving vehicle and the surrounding vehicle.

In a section in which a front end portion of the surrounding vehicle begins to overlap a rear end portion of the driving vehicle, the controller may be configured for controlling provided on a rear wheel of the driving vehicle, the flap of the variable wheel provided on a rear wheel of the driving vehicle, or the flap of the variable wheel provided on front and rear wheels of the driving vehicle, and may be configured for controlling a flap of the variable wheel disposed close to a side of the surrounding vehicle to rotate in the first direction, and control a flap of the variable wheel disposed away from a side of the surrounding vehicle to rotate in the second direction.

In a section in which a front end portion of the surrounding vehicle overlaps a rear end portion of the driving vehicle, and a rear end portion of the surrounding vehicle does not overlap the rear end portion of the driving vehicle, the controller may be configured for controlling the flap of the variable wheel provided on a front wheel of the vehicle, and among flaps of the variable wheel provided on the front wheel, may be configured for controlling a flap of the variable wheel disposed close to a side of the surrounding vehicle to rotate in the first direction, and may be configured for controlling a flap of the variable wheel disposed away from a side of the surrounding vehicle to rotate in the second direction.

The controller may be configured for controlling a rotation angle of the flap of the variable wheel to be reduced as an overlapping section between the driving vehicle and the surrounding vehicle increases.

In a section in which each of a front end portion and a rear end portion of the surrounding vehicles is disposed between a front end portion and a rear end portion of the driving vehicle, the controller may be configured for controlling the flap of the variable wheel provided on a rear wheel of the driving vehicle, and among flaps of the variable wheel provided on the rear wheel, may be configured for controlling the flap disposed close to a side of the surrounding vehicle to rotate in the second direction, and may be configured for controlling the flap disposed away from a side of the surrounding vehicle to rotate in the first direction.

In a section in which a front end portion of the surrounding vehicle passes by a front end portion of the driving vehicle, and a rear end portion of the surrounding vehicle is disposed between a front end portion and a rear end portion of the driving vehicle, the controller may be configured for controlling the flaps of the variable wheel provided on a front wheel and a rear wheel, and among flaps of the variable wheel provided on the front wheel and the rear wheel, may be configured for controlling the flap disposed close to a side of the surrounding vehicle to rotate in a second direction, and may include the flap disposed away from the surrounding vehicle to rotate in the first direction.

In a section after a rear end portion of the surrounding vehicle passes by a front end portion of the driving vehicle, the controller may be configured for controlling the flap of the variable wheel provided on a rear wheel of the driving vehicle, and among flaps of the variable wheel provided on the rear wheel, may be configured for controlling the flap disposed close to a side of the surrounding vehicle to rotate in the first direction, and may be configured for controlling the flap disposed away from a side of the surrounding vehicle to rotate in the second direction.

The external driving information may include information on an overall height of a surrounding vehicle driving close to the driving vehicle, and the controller may be configured for controlling the rotation angle of the flap of the variable wheel to be increased as the overall height of the surrounding vehicles is higher.

According to another aspect of the present disclosure, a control device of a variable wheel may include: a receiving unit configured to receive temperature information of a braking device; and a controller operatively connected to the receiving unit and configured to control a flap of the variable wheel to open or close an opening of the variable wheel provided to allow air to pass through a wheel, based on the temperature information of the braking device.

The controller may be configured for controlling the flap of the variable wheel to close the opening of the variable wheel when the vehicle drives off road.

In a case in which a temperature of the braking device exceeds a predetermined reference temperature, the controller may be configured for controlling the flap of the variable wheel to open the opening of the variable wheel provided to allow air to pass through the wheel.

The controller may be configured for controlling the flap of the variable wheel so that the air passes from the inside to the outside of the wheel.

According to an exemplary embodiment of the present disclosure, a control device of a variable wheel may minimize air resistance of a vehicle and improve aerodynamics by adjusting flaps of the variable wheel according to the driving situation.

Additionally, in the control device of the variable wheel according to an exemplary embodiment of the present disclosure, when the brakes overheat, the flap of the variable wheel may be adjusted to rapidly discharge overheated air to the outside thereof, preventing braking performance from deteriorating as well as improving braking performance.

Additionally, the control device of the variable wheel according to an exemplary embodiment of the present disclosure may adjust the flap of the variable wheel when steering the vehicle (for example, turning or changing lanes, etc.) to generate lateral force and moment acting on the vehicle, which may help prevent oversteer or understeer from occurring, and may improve the vehicle's reaction speed and handling performance.

Additionally, the control device of the variable wheel according to an exemplary embodiment of the present disclosure may be configured to predict crosswinds acting on the vehicle according to the ground clearance of a surrounding vehicle, and may adjusts the flap of the variable wheel, which may improve driving stability by alleviating unnecessary shaking of the vehicle.

Additionally, the control device of the variable wheel according to an exemplary embodiment of the present disclosure may adjust the flap of the variable wheel to block an opening or may be configured to generate air flow to the outside of the wheel, which may improve durability by blocking foreign objects from entering between wheel openings during off-road driving and preventing damage to the braking system.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a functional block diagram of a control device of a variable wheel according to an exemplary embodiment of the present disclosure.

FIG. 2 is a front view of a variable wheel according to an exemplary embodiment of the present disclosure.

FIG. 3 is a perspective view of a variable wheel according to an exemplary embodiment of the present disclosure.

FIG. 4 is a partially enlarged view of a variable wheel according to an exemplary embodiment of the present disclosure.

FIG. 5 is a perspective view of an integrated variable wheel according to another exemplary embodiment of the present disclosure.

FIG. 6 is a graph illustrating a change in drag coefficient Cd according to an angle of a flap according to an exemplary embodiment of the present disclosure.

FIG. 7 is a graph showing a change in lift coefficient Cl according to an angle of a flap according to an exemplary embodiment of the present disclosure.

FIG. 8 is a graph showing a change in side force coefficient Cs when flap directions of wheels provided on the left and right sides are controlled in reverse directions according to an exemplary embodiment of the present disclosure.

FIG. 9 is a diagram exemplarily illustrating offsetting of crosswind force according to an exemplary embodiment of the present disclosure.

FIG. 10 is a table illustrating aerodynamic contributions according to left and right wheel shapes according to an exemplary embodiment of the present disclosure.

FIG. 11 is a graph illustrating a change in drag coefficient Cd according to flap angles of left and right sides of a front wheel according to an exemplary embodiment of the present disclosure.

FIG. 12 is a graph illustrating a change in drag coefficient Cd according to flap angles of left and right sides of a rear wheel according to an exemplary embodiment of the present disclosure.

FIG. 13 is a graph illustrating a change in difference side force coefficient Cs according to an overall height of a passing vehicle and an interval between vehicles according to an exemplary embodiment of the present disclosure.

FIG. 14 is a flowchart of a control method of a variable wheel according to an exemplary embodiment of the present disclosure.

FIG. 15 is a graph illustrating a relationship between an angle of a flap and drag coefficient Cd according to an overall height of a vehicle according to an exemplary embodiment of the present disclosure.

FIG. 16 is a graph illustrating a relationship between an angle of a flap and drag coefficient Cd according to an overall height of a vehicle according to an exemplary embodiment of the present disclosure.

FIG. 17 is a graph illustrating air resistance and rolling resistance according to driving speed of a vehicle according to an exemplary embodiment of the present disclosure.

FIG. 18 is a diagram exemplarily illustrating a force and a moment acting on a driving vehicle depending on positions of a driving vehicle and surrounding vehicles according to another exemplary embodiment of the present disclosure.

FIG. 19 is a flowchart of a control method of a variable wheel according to another exemplary embodiment of the present disclosure.

FIG. 20 is a flowchart of a control method of a variable wheel according to another exemplary embodiment of the present disclosure.

FIG. 21 is a flowchart of a control method of a variable wheel according to another exemplary embodiment of the present disclosure.

FIG. 22 is a physical block diagram of a control device of a variable wheel according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure may make various changes and have various exemplary embodiments of the present disclosure, predetermined embodiments thereof will be described and illustrated in the drawings. However, the exemplary embodiments are not intended for limiting the present disclosure. The idea of the present disclosure should be construed to extend to any alterations, equivalents and substitutes besides the accompanying drawings.

It will be understood that although the terms first, second, etc., may be used herein to describe various elements, these elements should not be limited by these terms. These terms are generally only used to distinguish one element from another. For example, a first element could be termed a second element, and similarly, a second element could be termed a first element, without departing from the scope of the present disclosure. The term of and/or encompasses a combination of plural items or any one of the plural items.

The term used herein is for describing various exemplary embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein include the same meaning as commonly understood by one of ordinary skill in the art to which example embodiments of the present disclosure belong. It will be further understood that the terms, such as those defined in commonly used dictionaries, should be interpreted as including meanings that are consistent with their meanings in the context of the relevant art and will not be interpreted in an idealized or overly formal sense unless so defined herein.

Hereinafter, various exemplary embodiments of the present disclosure will be described with reference to the appended drawings.

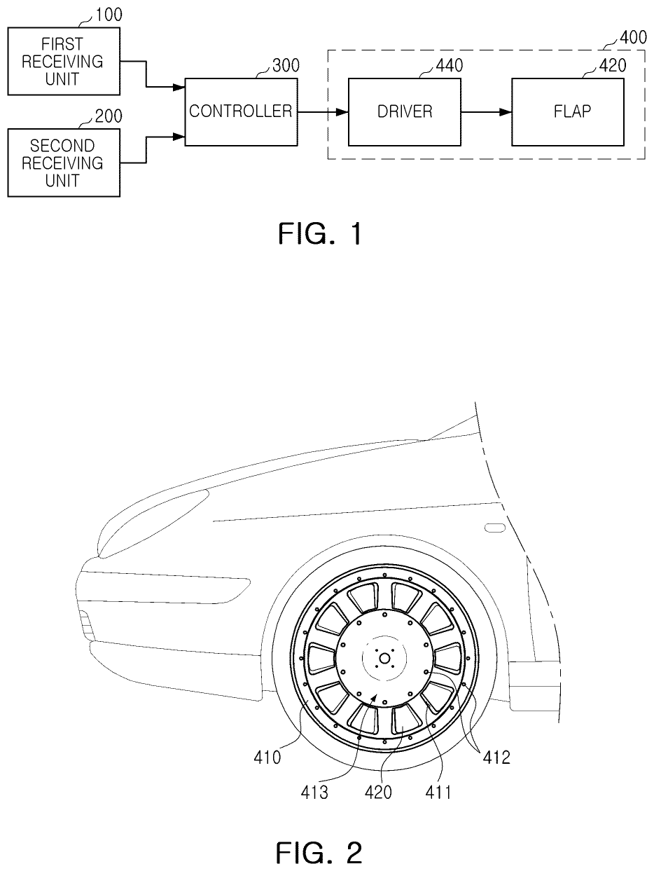

FIG. 1 is a block diagram of a control device of a variable wheel 400 according to an exemplary embodiment of the present disclosure.

The control device of the variable wheel 400 according to an exemplary embodiment of the present disclosure may include at least one of a first receiving unit 100 and a second receiving unit 200, and a controller 300.

The first receiving unit 100 may receive internal driving information of a vehicle.

The first receiving unit 100 may receive internal driving information of the vehicle, such as wheel rotation speed, vehicle driving speed, a lateral acceleration, a steering angle, brake pad temperature, and a yaw rate of the vehicle.

The first receiving unit 100 may be connected to sensors provided in the vehicle using a network provided in the vehicle and may receive the internal driving information on a driving state of the vehicle.

For example, the first receiving unit 100 may receive steering angle information from a steering angle sensor using a Controller Area Network (CAN) network of the vehicle.

The second receiving unit 200 may receive external driving information of the vehicle.

The second receiving unit 200 may receive external driving information such as a direction and a size of crosswind acting on the vehicle, an overall height of the vehicle approaching the vehicle, and relative position information.

For example, the second receiving unit 200 may receive information on whether a vehicle approaches the vehicle, or information on a relative position and a relative distance of the approaching vehicle, which is detected through one of Radio detection and ranging (RADAR), Light Detection and Ranging (LIDAR), a camera, an ultrasonic sensor, and an infrared sensor provided in the vehicle.

The controller 300 may be configured for controlling a direction and an adjustment angle of a flap 420 of the variable wheel 400, using at least one of the driving information of the vehicle received from the first receiving unit 100 and the external driving information of the vehicle received from the second receiving unit 200.

The controller 300 may be implemented through a non-volatile memory configured to store data relating to algorithms configured to control an operation of various components of a vehicle or software instructions that reproduce the algorithms, and a processor configured to perform operations described below using data stored in that memory.

Here, the memory and the processor may be implemented as individual chips. Alternatively, the memory and the processor may be implemented as a single chip integrated with each other. The processor may include the form of one or more processors.

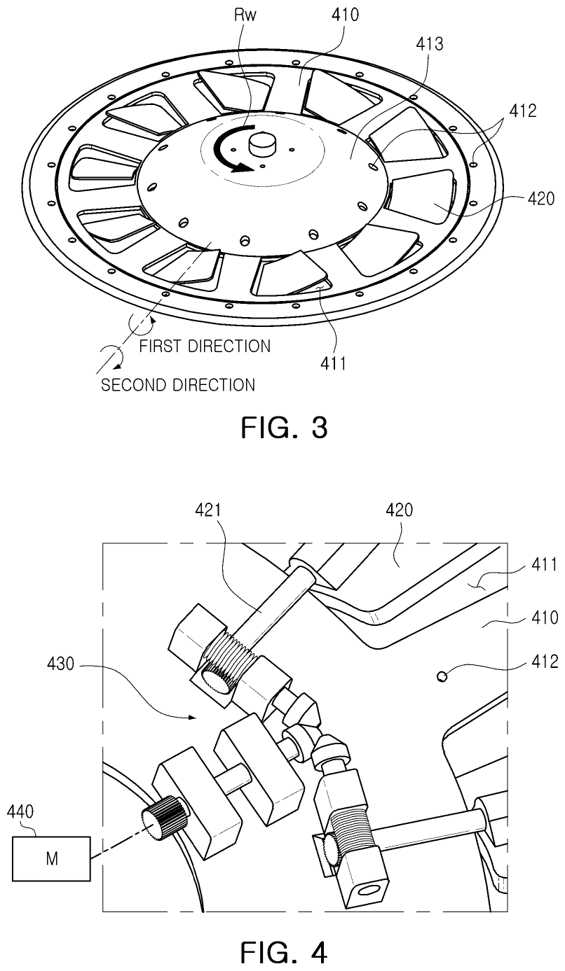

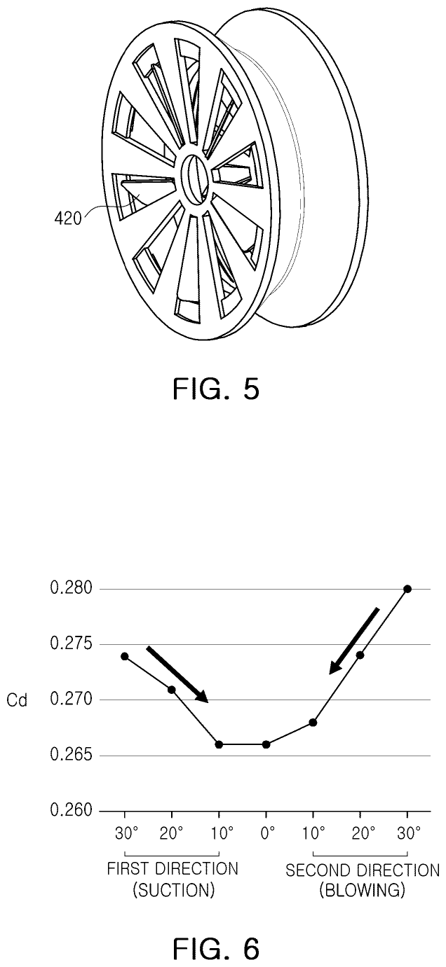

FIG. 2 is a front view of a variable wheel 400 according to an exemplary embodiment of the present disclosure, FIG. 3 is a perspective view of a variable wheel 400 according to an exemplary embodiment of the present disclosure, FIG. 4 is a partially enlarged view of a variable wheel 400 according to an exemplary embodiment of the present disclosure, and FIG. 5 is a perspective view of an integrated variable wheel according to another exemplary embodiment of the present disclosure.

Referring to FIG. 2 and FIG. 3, the variable wheel 400 according to an exemplary embodiment of the present disclosure may include a frame unit 410 forming a plurality of openings 411 and the opening 411, and a flap 420 that closes or opens the opening 411.

Referring to FIG. 3, the frame unit 410 may be manufactured in a form of a wheel cover.

Here, the frame unit 410 may further include a coupling hole which may be coupled to the wheel, and the opening 411 may be formed to correspond to a space in which a spoke of a coupled wheel is formed.

Because the variable wheel 400 according to an exemplary embodiment of the present disclosure may be coupled to an existing wheel frame with a coupling member (for example, a bolt) penetrating through a coupling hole formed to correspond to a coupling hole of the existing wheel frame, the variable wheel 400 may be compatible with an existing wheel, may be simple to install, and may be simple to maintain.

Referring to FIG. 5, the present disclosure is not limited thereto, and the variable wheel 400 may also be manufactured as an integrated structure with a base wheel, and the variable wheel 400 manufactured as an integrated structure may be structurally more robust and lighter in weight than a wheel cover type variable wheel 400.

Here, the flap 420 may be formed to close an opening 411, and may open or close the opening 411 depending on the rotation angle.

Additionally, the flap 420 may allow air to flow from an outside of the wheel to an inside thereof or may allow air to flow from the inside to the outside of the wheel, depending on a rotation direction.

Here, the rotation direction of the flap 420 that allows air to flow from the outside of the wheel to the inside may be referred to as a first direction, and the rotation direction of the flap 420 that allows air to flow from the inside of the wheel to the outside may be referred to as a second direction.

For example, in a case in which the wheel is rotated counterclockwise (Rw), when the flap 420 is rotated in the first direction, the air may flow in a direction in which external air is drawn in into the wheel.

Conversely, in a case in which the wheel is rotated counterclockwise (Rw), when the flap 420 is rotated in the second direction, the air may flow to discharge air inside the wheel to the outside.

Referring to FIG. 4, a rotation shaft 421 may be coupled to pass through an approximate center portion of an area of the flap 420, and the flap 420 may be supported on the frame unit 410 through the rotation shaft 421 extending toward the center portion of the frame unit 410 and may be rotatably provided.

Here, the rotation shaft 421 may pass through the approximate center portion of the area of the flap 420, symmetrically generating an air flow effect depending rotation of the flap 420 in the first direction or the second direction.

However, the present disclosure is not limited thereto, and depending on the user's needs, in a case in which the user desires to emphasize one of flows of air flowing inside or outside the wheel according to the angle of the flap 420, a shaft may be formed to deviate from the center portion of the area of the flap 420.

Here, when the vehicle moves forward, the first direction may be a direction in which air flow is adjusted to be formed at the inside of the wheel, and the second direction may be a direction in which air flow is adjusted to be formed at the outside of the wheel.

A driver 440 may rotate the flap 420 by transmitting rotational power to the rotation shaft 421 through a power transmission unit. The driver 440 and the power transmission unit 430 may be provided in a center portion 413.

Here, the power transmission unit may be comprised of a worm gear.

In a case in which the power transmission unit is provided with a worm gear, the flap 420 may be controlled more precisely using power of the driver 440, and due to small backlash, fixing force of the flap 420 may be increased even when power is not applied.

Here, the rotation angle of the flap 420 may be changed by receiving rotational power through the driver 440, through which aerodynamic force acting on the wheel may be adjusted.

Here, various electric motors or actuators, including step motors, may be applied to the driver 440, and the power transmission unit 430 coupled to the driver 440 may also transmit power using a plurality of gear units such as a ring gear other than a worm gear.

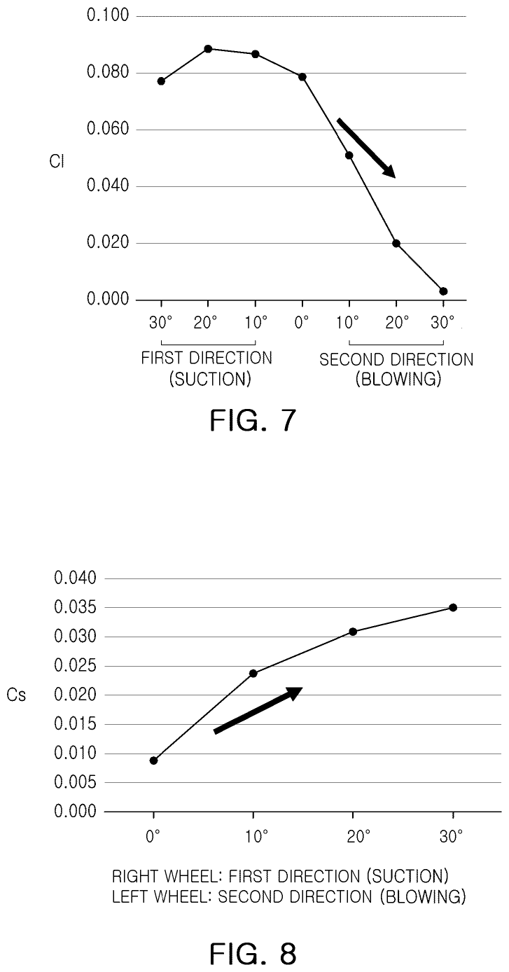

FIG. 6 is a graph illustrating a change in drag coefficient Cd depending on an angle of a flap 420 according to an exemplary embodiment of the present disclosure, FIG. 7 is a graph illustrating a change in lift coefficient Cl depending on an angle of a flap 420 according to an exemplary embodiment of the present disclosure, and FIG. 8 is a graph illustrating a change in side force coefficient Cs when directions of the flaps 420 of the wheels provided on left and right sides are controlled to be opposite to each other according to an exemplary embodiment of the present disclosure.

Here, a drag coefficient Cd may be a value indicating a magnitude of force applied when a vehicle rubs against air. With a decrease in a drag coefficient value, the air resistance acting on the vehicle may be reduced.

In other words, with a decrease in a value of the drag coefficient Cd, the air resistance acting on the vehicle may be reduced, improving fuel efficiency and driving stability of the vehicle.

Here, the fuel efficiency may refer to the amount of fuel consumed by the vehicle while driving a certain distance, and the driving stability may denote that the vehicle is capable of driving without shaking when driving in a straight line or turning.

Additionally, a lift coefficient Cl may be a value indicating a magnitude of force applied by the vehicle due to a difference in air pressure. When a value of the lift coefficient Cl is positive (+), the vehicle may be lifted upward, and when the value of the lift coefficient Cl is negative (−), the vehicle may be pushed down.

In other words, when the value of the lift coefficient Cl increases excessively, a vehicle body may be lifted upward and may not form sufficient friction with the ground, which may reduce the driving stability of the vehicle.

Additionally, when the value of the lift coefficient Cl decreases excessively, the vehicle body may be pressed down and may form excessive friction with the ground, which may cause excessive rolling during turning of the vehicle.

Accordingly, as the value of the lift coefficient Cl is closer to 0, there may be less interaction with air, fuel efficiency may be improved and fuel consumption may be reduced.

Additionally, a side force coefficient Cs may be a value indicating a magnitude of force applied by the vehicle due to crosswind. As a value of the side force coefficient Cs, there may be less influence by crosswind.

A yawing moment coefficient Cym may be a value indicating a magnitude of the moment generated by the vehicle due to crosswind. As a value of the yawing moment coefficient Cym is reduced, an occurrence of the moment may smaller.

As the value of the yawing moment coefficient Cym is reduced, a slipping phenomenon occurring during turning may be reduced, improving driving stability.

To improve aerodynamic performance of the vehicle, it may be required to reduce the value of the drag coefficient Cd, reduce the value of the lift coefficient Cl, increase the value of the side force coefficient Cs, and reduce the value of the yawing moment coefficient Cym.

In general, when the vehicle is designed to optimize aerodynamic performance during manufacturing, there is no separate means to adjust the aerodynamic performance after manufacturing.

In contrast, the control device of the variable wheel 400 according to an exemplary embodiment of the present disclosure may adjust a direction and an angle of the flap 420 of the variable wheel 400 provided on individual wheels of the vehicle, changing the aerodynamic performance of the vehicle and implementing optimized aerodynamic performance according to the driving situation.

Referring to FIG. 6, when the angle of the flap 420 is ‘0 (zero),’ that is, when the flap 420 closes an opening, the drag coefficient Cd of the vehicle may be the smallest.

Additionally, when the flap 420 is rotated to the same size, it may be seen that the drag coefficient Cd when rotating in the first direction tends to be lower than the drag coefficient Cd when rotating in the second direction.

Accordingly, as the angle of the flap 420 decreases, air resistance may be reduced, and it may be confirmed that when the flap 420 is rotated at the same angle, a case of opening in the first direction is more advantageous in terms of air resistance than a case of opening in the second direction.

Referring to FIG. 7, it may be confirmed that when the flap 420 is rotated in the second direction to open an opening 411, as the rotation angle increases, lift force acting on the vehicle may be reduced.

FIG. 8 is a view exemplarily illustrating a side force coefficient Cs when the variable wheel 400 provided on a left side of the vehicle rotates the flap 420 in the second direction, and the variable wheel 400 provided on a right side rotates the flap 420 in the first direction to open the opening 411.

Here, it may be confirmed that when force from the left to the right of the vehicle is set to include a positive value, as the angle of the variable wheel 400 increases, side force acts in a right direction approximately in proportion to the angle.

In the flap 420 of the variable wheel 400 according to an exemplary embodiment of the present disclosure, when the angle of the flap 420 is ‘0 (zero),’ an air flow rate passing through the flap 420 may be less than 100 CMH (cubic meters per hour), which may be considered to be almost blocked.

In the instant case, overheating may occur in a brake, and the brake may be cooled by opening the flap 420. Here, the flap 420 may be proportional as the open angle increases, and a passing flow rate may increase.

Meanwhile, when opening the flap 420, the brake may be cooled as air flows through the opening 411 of the wheel, but aerodynamic performance will inevitably deteriorate.

Furthermore, when adjusting the flap 420 in a closing direction to improve the aerodynamic performance of the vehicle, the opening 411 of the wheel may be reduced to improve the aerodynamic performance of the vehicle, but the braking performance may be inevitably weakened.

Here, the flap 420 of the variable wheel 400 according to an exemplary embodiment of the present disclosure rotates the flap 420 in the second direction when the brake overheats, the brakes may be cooled by increasing the flow rate of air.

In the variable wheel 400 according to an exemplary embodiment of the present disclosure, the flap 420 rotated in the second direction rotates together with the wheel and the passing flow rate may be maximized due to an effect of a fan, enabling more rapid cooling.

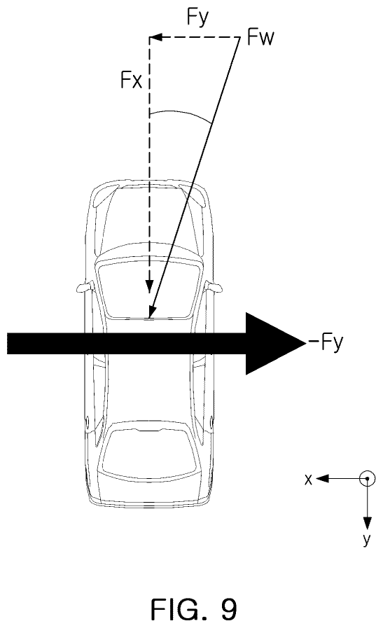

FIG. 9 is a diagram exemplarily illustrating offsetting of crosswind force according to an exemplary embodiment of the present disclosure.

Referring to FIG. 9, wind including a predetermined yaw angle may blow toward the vehicle due to changes in lanes, turning, and changes in a wind direction.

Wind force (Fw) hitting the vehicle may be separated into an x component (Fx) that acts in a direction of driving a vehicle and a y component (Fy) that acts in a side surface of the direction of driving the vehicle.

In a vehicle provided with a variable wheel 400 according to an exemplary embodiment of the present disclosure, when the variable wheel 400 provided on a left side of the vehicle rotates the flap 420 in the second direction, and the variable wheel 400 provided on a right side rotates the flap 420 in the first direction, crosswind force (−Fy) may be generated in a vehicle in a direction opposite to the y component (Fy) of wind force (Fw) hitting the vehicle.

Additionally, in a vehicle provided with a variable wheel 400 according to an exemplary embodiment of the present disclosure, as the crosswind force increases in proportion to the angle of the flaps 420 provided on the left and right sides, an angle of the flap 420 may be adjusted to generate force corresponding to the y component (Fy) of the wind force (F), offsetting the crosswind force caused by the wind and improving the driving stability of the vehicle.

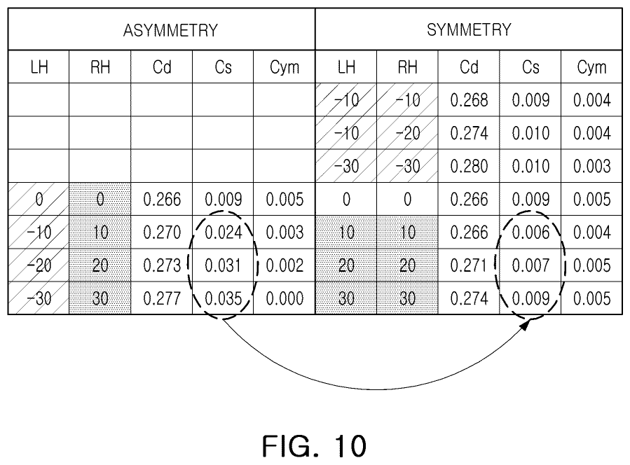

FIG. 10 is a table illustrating aerodynamic contributions according to left and right wheel shapes according to an exemplary embodiment of the present disclosure.

When a spoke of the wheel frame includes an airfoil cross-sectional shape, when producing a wheel frame with a single mold, there are cases in which a wind flow was formed opposite to the left and right sides according to the rotation of wheels of the vehicle.

In the instant case, air flow in opposite directions occurred in left and right wheels (for example, in the case in which the air flow occurs from the outside to the inside of a wheel in a left wheel, when the wheels are disposed on a right side in the same shape, air may flow from the inside of the wheel to the outside), and thus, lateral forces inevitably acted in vehicles depending on an arrangement of the wheels.

Additionally, as the vehicle is driven at higher speeds, the lateral force acting on the vehicle may increase, and thus, the vehicle may be pulled to one side due to the lateral force, which may impede driving stability.

Referring to FIG. 10, when the flap 420 of the variable wheel 400 provided on a left side and a right side of the vehicle is adjusted asymmetrically, side force coefficient Cs of the vehicle may occur significantly.

Here, in a case in which the flap 420 of the variable wheel 400 provided on the left side and the right side of the vehicle is adjusted asymmetrically, this may denote that, when the flap 420 provided on the left side of the vehicle rotates in the first direction, the flap 420 provided on the right side rotates in the second direction, and when the flap 420 provided on the left side of the vehicle rotates in the second direction, the flap 420 provided on the right side rotates in the first direction.

Additionally, when the flaps 420 of the variable wheels 400 provided on the left side and the right side of the vehicle are adjusted symmetrically, the side force coefficient Cs of the vehicle may be reduced.

Here, in a case in which the flaps 420 of the variable wheels 400 provided on the left and right sides of the vehicle are adjusted symmetrically, this may denote that, when the flap 420 provided on the left side of the vehicle rotates in the first direction, the flap 420 provided on the right side rotates in the first direction, and when the flap 420 provided on the left side of the vehicle rotates in the second direction, the flap 420 provided on the right side rotates in the second direction.

As illustrated in FIG. 10, a controller 300 may independently control the flaps 420 of the variable wheels 400 provided on the left side and the right side of the vehicle, in a symmetrical manner or in an asymmetrical manner.

Accordingly, in a case in which the wheel is manufactured in a single mold, the flaps 420 of the variable wheels 400 provided on the left side and the right side of the vehicle may be independently controlled to improve a leaning phenomenon while driving the vehicle.

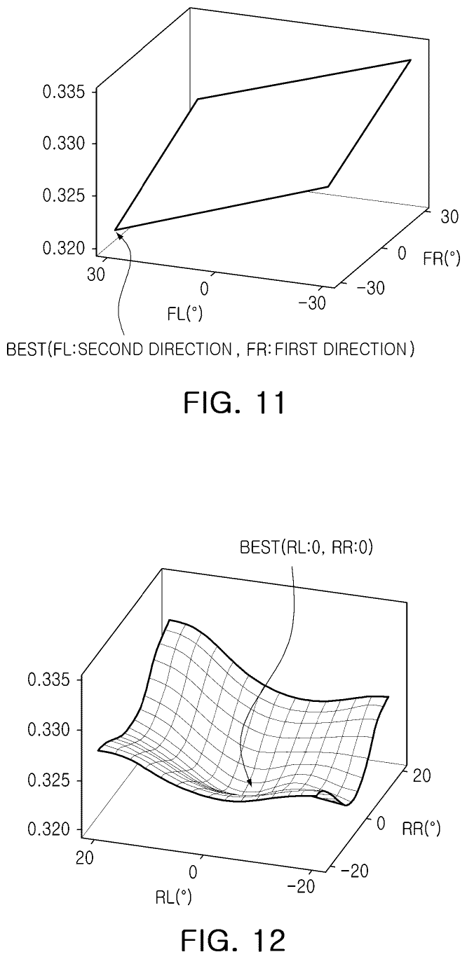

FIG. 11 is a graph illustrating a change in drag coefficient Cd depending on the angle of flaps 420 on a left side and a right side of a front wheel according to an exemplary embodiment of the present disclosure, and FIG. 12 is a graph illustrating a change in drag coefficient Cd according to the angle of flaps 420 on a left side and a right side of a rear wheel according to an exemplary embodiment of the present disclosure.

FIG. 11 and FIG. 12 may be data confirming the change in drag coefficient Cd according to the angle of the flaps 420 on the left side and the right side of the vehicle, in a situation in which the wind blows at 140 km/h (kilometers per hour) 10 degrees to the left of the center portion of the vehicle.

Referring to FIG. 11, when a left side of a front wheel rotates in the second direction and a right side thereof rotates in the first direction, the drag coefficient (Cd) acting on the vehicle may be the smallest.

In other words, the wind may blow out from the wheel on the left side of the front wheel to the outside of the wheel, and the wind may blow into the inside of the wheel from the wheel on the right side.

Additionally, referring to FIG. 12, when both flaps 420 on the left side and the right side of a rear wheel are closed, the drag coefficient Cd acting on the vehicle may be the smallest.

In a situation in which the wind blows at 140 km/h (kilometers per hour) 10 degrees to the left on the center portion of the vehicle, it may be confirmed that the flap 420 of the left wheel of the front wheel may be opened by 30 degrees in the second direction, and the flap 420 of the right wheel of the front wheel is opened by 30 degrees in the first direction, and the aerodynamic force generated when driving the vehicle with the flap 420 on the left side and the right side of the rear wheel closed is improved by approximately 4 counts as compared to a case of closing all the flaps 420 provided in the vehicle.

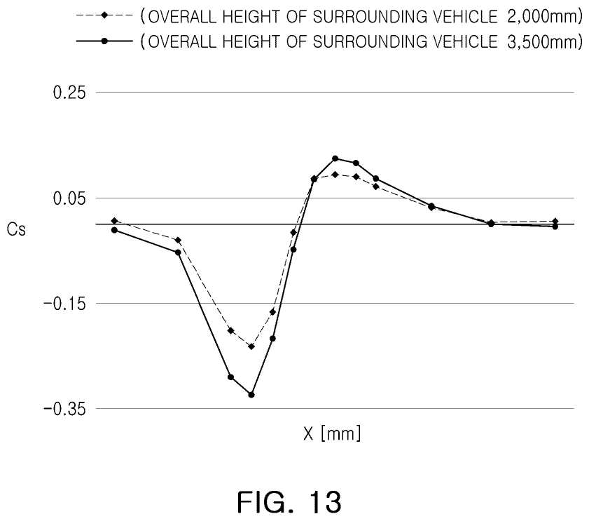

FIG. 13 is a graph illustrating a change in difference side force coefficient Cs according to an overall height of a passing vehicle and an interval between vehicles according to an exemplary embodiment of the present disclosure.

In a case in which a surrounding vehicle 2 passes by the driving vehicle 1 provided with the variable wheel 400 according to an exemplary embodiment of the present disclosure, the surrounding vehicle 2 may pass by the driving vehicle 1 while pushing air at high speed so that a high-pressure region may be formed in the front of the driving vehicle 1, and a low-pressure region may be formed in the rear of the driving vehicle 1.

Referring to FIG. 13, the size of the high-pressure or low-pressure region may be determined depending on the overall height of the surrounding vehicle 2 that overtakes the driving vehicle 1. Additionally, when the surrounding vehicle 2 overtakes the driving vehicle 1 as the overall height of the surrounding vehicle 2 increases, larger lateral force may be generated in the driving vehicle 1.

To explain in more detail with reference to FIG. 13, in a case in which the surrounding vehicle 2 approaches from the rear of the driving vehicle 1, when a relative distance between the driving vehicle 1 and the surrounding vehicle 2 approaches within a certain distance, lateral force may be generated on the driving vehicle 1 due to the influence of the surrounding vehicle 2.

The influence of the lateral force of the surrounding vehicle 2 approaching from the rear may increase as the relative distance between the driving vehicle 1 and the surrounding vehicle 2 becomes closer, and when direction of lateral force generated on the driving vehicle 1 in case that the surrounding vehicle 2 approaches from the rear and direction of lateral force generated by the driving vehicle 1 in case that the surrounding vehicle 2 overtakes and moves away from the front of the driving vehicle 1, may be opposite to each other

On the other hand, when a relative distance between the driving vehicle 1 and the surrounding vehicle 2 becomes farther than a certain distance, the influence of the surrounding vehicle 2 may be reduced, and thus, a magnitude of the lateral force generated on the driving vehicle 1 may be reduced so that the driving vehicle may escape from the influence of the surrounding vehicle 2.

The second receiving unit 200 may detect the overall height of the surrounding vehicle 2 overtaking the driving vehicle 1 or may receive information on the sensed overall height, and the controller 300 may improve aerodynamic performance by adjusting the angle and the rotation direction of the flap 420 of the variable wheel 400 based on the received overall height.

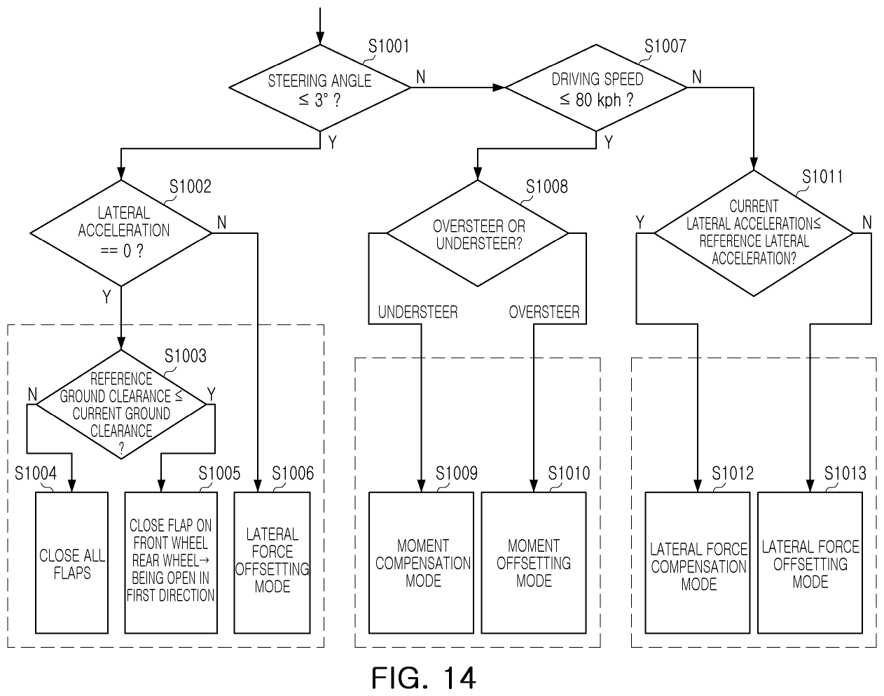

FIG. 14 is a flowchart of a control method of a variable wheel 400 according to an exemplary embodiment of the present disclosure.

In the control method of the variable wheel 400 according to an exemplary embodiment of the present disclosure, a controller 300 may confirm whether a steering angle of the driving vehicle is ±3° or less (S1001).

The controller 300 may receive steering angle information through the first receiving unit 100 and may confirm whether the received steering angle is ±3° or less.

When the received steering angle is ±3° or less, the controller 300 may confirm whether lateral acceleration is approximately 0 (zero) (S1002).

When the steering angle is ±3° or less, the vehicle may be considered to be driving approximately in a straight line, and when the vehicle drives in a straight line, when there is no crosswind, the lateral acceleration may be approximately 0 (zero).

When the lateral acceleration is approximately 0 (zero), the controller 300 may be configured to determine the angle of the flap 420 of the variable wheel 400 according to the ground clearance of the vehicle.

Here, ground clearance may refer to a vertical distance between a lower floor of the vehicle and a ground surface.

The controller 300 may confirm whether current ground clearance of the vehicle is lower than reference ground clearance (S1003).

Here, the reference ground clearance may be a reference ground clearance when determining the design of the vehicle.

For example, the design of a vehicle may be tested at a constant wind speed in a condition in which certain weight is applied to the vehicle within a wind tunnel (for example, a total of 210 kg assuming a ride of three adults of 70 kg), and may be designed to exhibit optimal aerodynamic performance, and ground clearance of a design that optimizes aerodynamic performance may be set as reference ground clearance.

Furthermore, the controller 300 may receive information on suspension in which through the first receiving unit 100, a state of ground clearance of a current vehicle is changed according to the weight change of the vehicle, and determine whether the ground clearance of the current vehicle is higher or lower than the reference ground clearance, ground level based on the suspension information.

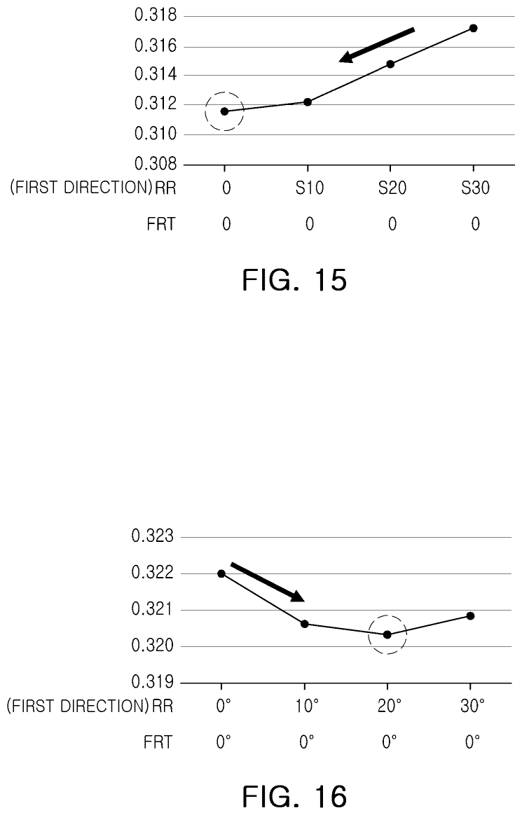

FIG. 15 is a graph illustrating a relationship between an angle of a flap 420 and drag coefficient Cd when ground clearance of a vehicle according to an exemplary embodiment of the present disclosure is low, and FIG. 16 is a graph illustrating a relationship between an angle of a flap 420 and drag coefficient Cd when ground clearance of a vehicle according to an exemplary embodiment of the present disclosure is high.

In general, the design of the vehicle is designed to demonstrate optimal aerodynamic performance when a test is conducted at constant wind speed (for example, a wind direction being a yaw angle of 0° and wind speed being 140 km/h), in a state where a certain weight is applied to the vehicle in the wind tunnel (for example, a total of 210 kg assuming a ride of three adults of 70 kg).

Accordingly, when the ground clearance of the vehicle changes according to the change in weight considered during the design of the vehicle, the aerodynamic performance of the vehicle may also change.

Accordingly, the ground clearance of the design that optimizes the aerodynamic performance of the vehicle may be set in advance as the reference ground clearance, and the reference ground clearance may be compared with the ground clearance of the currently driving vehicle to determine whether the ground clearance is higher or lower than the reference ground clearance and adjust the flap 420, improving the aerodynamic performance.

Referring to FIG. 15, there may be cases in which the current ground clearance is lower than the reference ground clearance.

When the current ground clearance is lower than the reference ground clearance, it was confirmed that the drag coefficient is minimized when the flaps 420 of the front and rear wheels are closed, that is, when the rotation angle is 0 (zero) °.

For example, the reference ground clearance may be the ground clearance when the vehicle includes a weight of 210 kg (for example, assuming a ride of three adults of 70 kg), and when the vehicle is loaded with a weight of 210 kg or more, as the weight of the vehicle increases, the ground clearance of the vehicle may be lowered.

Additionally, the current ground clearance may be confirmed through a state of the suspension which is changed due to force applied in a direction of gravity of the vehicle.

Conversely, referring to FIG. 16, there may be cases in which the current ground clearance is higher than the reference ground clearance.

When the current ground clearance is higher than the reference ground clearance, it was confirmed that the highest aerodynamic performance is shown when the flap 420 of the front wheel is closed, that is, the rotation angle is 0 (zero) °, and the flap 420 of the rear wheel is rotated by approximately 20° in the first direction.

Here, the reference ground clearance may be the ground clearance when the vehicle has a weight of 210 kg (for example, assuming a ride of three adults of 70 kg), and when only a driver is on board (less than 210 kg), the weight of the vehicle may be lowered, so that the ground clearance of the vehicle may be increased.

Referring again to FIG. 14, in a case in which the current ground clearance of the vehicle is lower than the reference ground clearance, the controller 300 may close an opening 411 by setting the rotation angle of all flaps 420 to 0 (zero)° (S1004).

Additionally, when the current ground clearance of the vehicle is higher than the reference ground clearance, the controller 300 may close the opening 411 by setting the rotation angle of the flap 420 provided on the front wheel to 0 (zero) °, and may rotate the rotation angle of the flap 420 provided on the rear wheel in the first direction so that external air may be allowed to flow into the inside of the wheel (S1005).

Here, referring to FIG. 16, to optimize aerodynamic performance, the controller 300 may rotate the rotation angle of the flap 420 provided on the rear wheel to 20° in the first direction.

When the lateral acceleration is not approximately 0 (zero), the controller 300 may adjust the flap 420 in a lateral force offsetting mode (S1006).

The lateral force offset mode may be a mode in which the flap 420 provided on the left wheel and the flap 420 provided on the right wheel are asymmetrically adjusted so that lateral force acts in an opposite direction to which crosswind acts.

For example, in a case in which the crosswind acts from right to left, the vehicle may be pulled to the left.

In the instant case, the controller 300 may rotate the flap 420 provided on the left wheel in the second direction and rotate the flap 420 provided on the right side in the first direction, generating lateral force from the left to the right of the vehicle.

Here, the lateral force may increase in proportion to the driving speed of the vehicle, that is, the rotation speed of the wheels and the rotation angle of the flap 420.

Accordingly, in the case of generating lateral force of the same magnitude, the controller 300 may increase the rotation angle of the flap 420 when the driving speed of the vehicle is low, and may decrease the rotation angle of the flap 420 when the driving speed of the vehicle is high, adjusting the magnitude of the lateral force.

In a case in which the steering angle received through the first receiving unit 100 exceeds±3°, the controller 300 may confirm whether the driving speed of the vehicle is less than or equal to predetermined reference speed (for example, 80 km/h) (S1007).

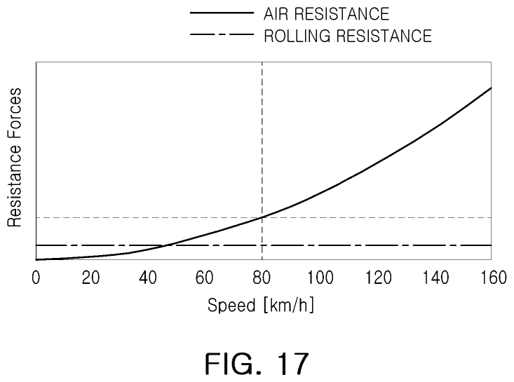

FIG. 17 is a graph illustrating air resistance and rolling resistance according to driving speed of a vehicle according to an exemplary embodiment of the present disclosure.

Referring to FIG. 17, rolling resistance may occur relatively continuously regardless of driving speed of the vehicle.

In contrast, air resistance may increase approximately in proportion to the square of the driving speed of the vehicle.

Accordingly, if the driving speed of the vehicle is 80 km/h or more, air resistance may have a relatively greater effect on the resistance acting on a vehicle than rolling resistance. Additionally, when the vehicle's driving speed is 140 km/h or more, air resistance may rapidly increase.

Referring again to FIG. 14, when the driving speed of the vehicle is less than or equal to predetermined reference speed (e.g., 80 km/h), the controller 300 may confirm whether oversteer or understeer has occurred in the vehicle (S1008).

Here, oversteer may be a state in which a turning radius becomes smaller than an angle at which a steering wheel is rotated while the vehicle is turning. In other words, this may be a case in which moment occurs more significantly than a turning path of the vehicle.

Here, understeer may be a state in which the turning radius becomes greater than an angle at which a steering wheel is rotated while the vehicle is turning. In other words, this may be a case in which moment occurs smaller than the turning path of the vehicle.

The controller 300 may confirm whether oversteer or understeer of the vehicle has occurred based on the driving speed of the vehicle and the steering angle of the vehicle received through the first receiving unit 100.

For example, the controller 300 may confirm whether oversteer or understeer of the vehicle has occurred, using a yaw rate error amount which is a different between a current yaw rate and a target yaw rate determined by the driving speed and the steering angle of the vehicle received through the first receiving unit 100.

However, the present disclosure is not limited thereto, and the controller 300 may confirm whether oversteer or the understeer of the vehicle has occurred, using estimation of a lateral slip angle of the vehicle, and various methods to confirm whether the oversteer or the understeer of the vehicle has occurred may be applied to the present disclosure.

When understeer occurs in the vehicle, the controller 300 may be configured for controlling the flap 420 in a moment compensation mode to compensate for moment insufficient in the vehicle (S1009).

For example, when understeer occurs while the vehicle turns to the left and drives, the controller 300 may rotate the flap 420 provided on the left side of the front wheel, in the first direction, and may rotate the flap 420 provided on the right side of the front wheel, in the second direction.

Additionally, the controller 300 may rotate the flap 420 provided on the left side of the rear wheel, in the second direction, and may rotate the flap 420 provided on the right side of the rear wheel, in the first direction.

In other words, when understeer occurs while the vehicle turns to the left and drives, the flap 420 may be controlled so that lateral force is generated to the left at the front wheel, and the flap 420 may be controlled so that lateral force is generated to the right at the rear wheel, and thus, understeer may be alleviated by generating additional moment in a turning direction of the vehicle.

In a case in which oversteer occurs in the vehicle, the controller 300 may be configured for controlling the flap 420 in a moment offset mode to offset excessive moment in the vehicle (S1010).

For example, when oversteer occurs while the vehicle turns to the left and drives, the controller 300 may rotate the flap 420 provided on the left side of the front wheel, in the second direction, and may rotate the flap 420 provided on the right side of the front wheel, in the first direction.

Additionally, the controller 300 may rotate the flap 420 provided on the left side of the rear wheel, in the first direction, and may rotate the flap 420 provided on the right side of the rear wheel, in the second direction.

In other words, when oversteer occurs while the vehicle turns to the left and drives, the flap 420 may be controlled so that lateral force is generated to the right at the front wheel, and the flap 420 may be controlled so that lateral force is generated to the left at the rear wheel, and thus, oversteer may be alleviated by generating additional moment in an opposite direction of the turning direction of the vehicle.

Here, in S1009 and S1010, the rotation angle of the flap 420 may be adjusted based on the degree of occurrence of oversteer or understeer and the driving speed of the vehicle.

For example, the controller 300 may be configured for controlling the rotation angle of the flap 420 to increase as an occurrence degree of oversteer or understeer increases, and may be configured for controlling the rotation angle of the flap 420 to decrease as the driving speed of the vehicle increases.

In a case in which the driving speed of the vehicle exceeds predetermined reference speed (e.g., 80 km/h), the controller 300 may confirm whether current lateral acceleration is less than or equal to reference lateral acceleration (S1011).

Referring again to FIG. 17, in a case of high-speed driving exceeding 80 km/h, because air resistance increases rapidly, aerodynamic performance in a high-speed driving section may be improved, improving fuel efficiency of the vehicle.

Additionally, the driving stability of the vehicle may be improved by offsetting effects of a lane change during high-speed driving or crosswind when driving in a straight line.

In a case in which the current lateral acceleration is less than the reference lateral acceleration, the controller 300 may be configured for controlling the flap 420 of the variable wheel 400 in a lateral force compensation mode to compensate for the insufficient lateral acceleration (S1012).

For example, while a lane of the vehicle changes a lane on the left side, in a case in which the current lateral acceleration is less than the reference lateral acceleration, the controller 300 may compensate for insufficient lateral acceleration by generating lateral force from the right side to the left side of the vehicle, by allowing the flap 420 provided on the left wheel to rotate in the first direction, and allowing the flap 420 provided on the right side to rotate in the second direction,

Here, since the lateral force is proportional to the rotation angle of the flap 420 and the driving speed of the vehicle, the controller 300 may adjust the rotation angle of the flap 420 in inverse proportion to the driving speed of the vehicle.

For example, in a case in which compensation of the same magnitude of lateral force is required, the controller 300 may adjust the rotation angle of the flap 420 to be greater when the driving speed of the vehicle is slow than when the driving speed of the vehicle is fast.

In a case in which the current lateral acceleration exceeds the reference lateral acceleration, the controller 300 may be configured for controlling the flap 420 of the variable wheel 400 in a lateral force offset mode to offset excessive lateral acceleration (S1013).

For example, while a lane of the vehicle changes a lane on the left side, in a case in which the current lateral acceleration exceeds the reference lateral acceleration, the controller 300 may rotate the flap 420 provided on the left wheel, in the second direction, and may rotate the flap 420 provided on the right wheel, in the first direction, which may reduce excessive lateral acceleration by generating lateral force from the left to the right of the vehicle.

Here, since the lateral force is proportional to the rotation angle of the flap 420 and the driving speed of the vehicle, the controller 300 may adjust the rotation angle of the flap 420 in inverse proportion to the driving speed of the vehicle.

For example, in a case in which compensation of the same magnitude of lateral force is required, the controller 300 may adjust the rotation angle of the flap 420 to be greater when the driving speed of the vehicle is low than when the driving speed of the vehicle is high.

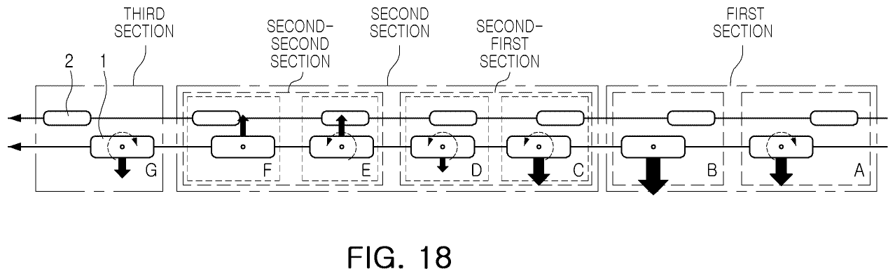

FIG. 18 is a view exemplarily illustrating force and moment acting on a driving vehicle 1 according to a position of the driving vehicle 1 and surrounding vehicles 2 according to another exemplary embodiment of the present disclosure.

When the vehicle is driving, the surrounding vehicle 2 may overtake the driving vehicle 1, or the driving vehicle 1 may drive while overtaking the surrounding vehicle 2.

Here, depending on the relative position of the driving vehicle 1 and the surrounding vehicles 2, the force and the moment generated in the driving vehicle 1 may change.

Accordingly, the controller 300 may adjust the flap 420 of the variable wheel 400 according to the relative position of the driving vehicle 1 and the surrounding vehicle 2, thus achieving optimal aerodynamic performance.

The relative position of the driving vehicle 1 and the surrounding vehicles 2 may be roughly divided into a first section, a second section, and a third section, of which the second section may be divided into a second-first section and a second-second section.

Hereinafter, explanation may be made on the assumption that the surrounding vehicle 2 overtakes the vehicle 1 on the right side of a driving direction.

Here, the first section may be a section in which the driving vehicle 1 begins to overlap the surrounding vehicle 2.

In the first section, as the surrounding vehicles 2 approach the driving vehicle 1, lateral force pushing in an opposite direction of the approaching surrounding vehicle 2 may increase, and the first section may be the section on which a magnitude of the lateral force acts the greatest.

Here, the first section may include position A and position B.

Position A and position B may be determined based on a position of a front end portion of the surrounding vehicle 2.

Position A may be a position from a section in which the front end portion of the surrounding vehicle 2 begins to overlap the driving vehicle 1 to a point at which a position of the front end portion of the surrounding vehicle 2 overlapping the driving vehicle 1 is up to 5% of a length of the driving vehicle 1.

As the surrounding vehicle 2 enters position A, the driving vehicle 1 may be considered to be in an area of influence of air resistance caused by the surrounding vehicles 2.

In a case in which the surrounding vehicle 2 is in position A, a clockwise moment may occur in the driving vehicle 1 and lateral force pushing in an opposite direction of the surrounding vehicle 2 may increase.

Position B may be a position in which a position of the front end portion of the surrounding vehicle 2 overlapping the driving vehicle 1 is 5 to 50% of a length of the driving vehicle 1.

In a case in which the surrounding vehicle 2 is in position B, the driving vehicle 1 may include a point at which the clockwise moment gradually decreases and disappears, and may include a maximum point of the lateral force pushing in the opposite direction of the surrounding vehicle 2.

Additionally, the second section may be a section from a point at which the front end portion of the surrounding vehicle 2 passes through a center portion of the driving vehicle 1 to a point at which the overlapping section with the driving vehicle 1 disappears.

The second section is a section in which surrounding vehicles 2 pass by the driving vehicle 1, and in an initial section, directions of the force and the moment generated by the surrounding vehicle 2 may be consistent with each other, and in a final section, the direction of the force and the moment may be changed to the directions of the force and the moment generated by the surrounding vehicle 2.

Here, the initial section may be referred to as the second-first section, and the final section may be referred to as the second-second section.

The second-first section may include position C and position D, and the second-second section may include position E and position F.

Position C may be a point at which the front end portion of the surrounding vehicle 2 passes by the center portion of the driving vehicle 1.

In position C, moment opposite to that of the first section, that is, a counterclockwise moment, may occur, and lateral force pushing in the opposite direction of the surrounding vehicle 2 may occur.

Position D may be a position in which an overlapping section between the driving vehicle 1 and the surrounding vehicle 2 is disposed between 50 and 100% of the length of the driving vehicle 1, and a distal end portion of the surrounding vehicle 2 still does not overlap the driving vehicle 1.

In position D, moment may occur in the same direction as position C, that is, in the counterclockwise direction, and lateral force pushing in the opposite direction of the surrounding vehicle 2 may be generated, but a magnitude thereof may decrease as the overlapping section increases.

Position E may be a position of a point at which an overlapping section between the driving vehicle 1 and the surrounding vehicle 2 is disposed between 50 and 100% of a length of the driving vehicle 1, and a distal end portion of the surrounding vehicle 2 begins to overlap the driving vehicle 1.

In position E, moment in the same direction as position D, that is, a counterclockwise moment, may occur, but a magnitude thereof may decrease as the overlapping section increases, and unlike positions A to D, lateral force pulling in a direction of the surrounding vehicle 2 may occur.

Position F may be a position in which a front end portion of the surrounding vehicle 2 has passed by the driving vehicle 1 and a distal end portion of the surrounding vehicle 2 is in an overlapping section with the driving vehicle 1.

Position F may include a point at which moment in the same direction as the E position, that is, a counterclockwise moment, may occur, but a magnitude thereof may decrease as an overlapping section increases and the magnitude disappears.

Additionally, similarly to position F, lateral force pulling in the direction of the surrounding vehicle 2 may occur, and a maximum point of the lateral force pulling in the direction of the surrounding vehicle 2 may be included.

Additionally, the third section may be a section in which the distal end portion of the surrounding vehicle 2 does not overlap the driving vehicle 1, that is, the surrounding vehicle 2 overtakes the driving vehicle 1 and deviates from the driving vehicle 1.

The third section may be a section in which the moment the surrounding vehicle 2 deviates from the driving vehicle 1, a direction of force is changed once more due to the influence of slipstream.

That is, the third section is in an opposite direction to the second section, and in the third section, clockwise moment in the same direction as the first section may occur, and lateral force pushing in the opposite direction of the surrounding vehicle 2 may be generated.

As described above, the direction and magnitude of force and moment between the driving vehicle 1 and the surrounding vehicle 2 may be changed depending on a relative position thereof during the process of overtaking.

According to another exemplary embodiment of the present disclosure, when the vehicle overtakes, the flaps 420 of the variable wheels 400 provided on the vehicle may be individually controlled according to changed force and moment, securing aerodynamic performance and driving stability.

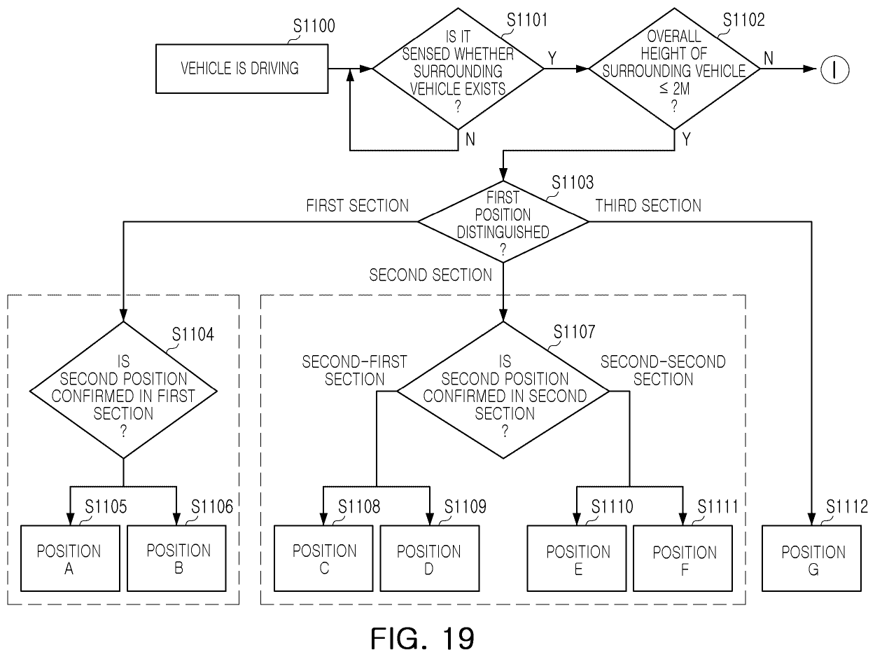

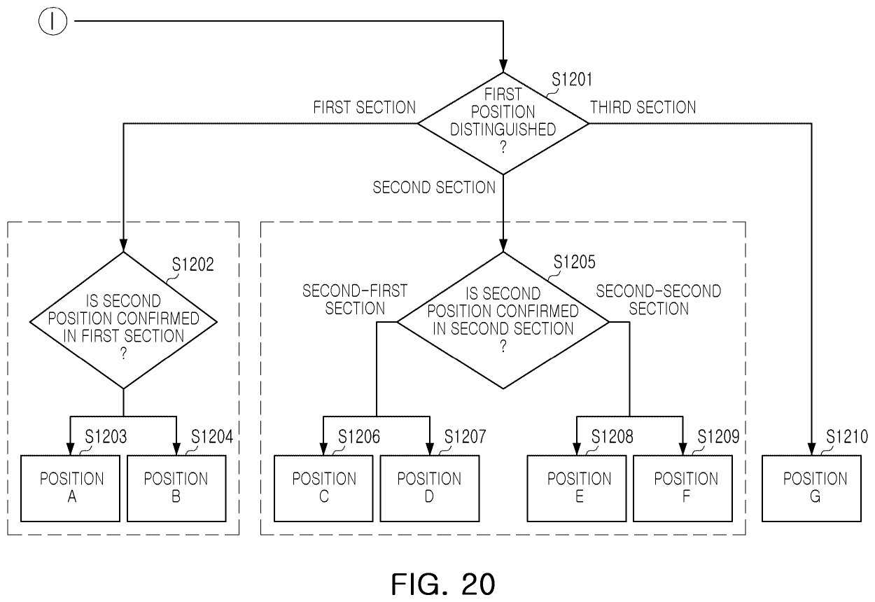

FIG. 19 is a flowchart of a control method of a variable wheel 400 according to another exemplary embodiment of the present disclosure, and FIG. 20 is a flowchart of a control method of a variable wheel 400 according to another exemplary embodiment of the present disclosure.

Referring to FIG. 19, a second receiving unit 200 may sense a surrounding vehicle 2 approaching a surrounding vehicle 1 (S1100), and the controller 300 may continuously sense whether the surrounding vehicle 2 approaches from the second receiving unit 200 (S1101).

Here, the second receiving unit 200 may receive information on whether the surrounding vehicle 2 approaches, and information on an overall height of the surrounding vehicle 2 and a relative position of the surrounding vehicle 2 and the driving vehicle 1, using Radio detection and ranging (RADAR), Light Detection and Ranging (LiDAR), a camera, an ultrasonic sensor, and an infrared sensor provided in the vehicle.

When the surrounding vehicle 2 is sensed, the controller 300 may confirm whether an overall height of the surrounding vehicle 2 approaching the driving vehicle 1 is less than or equal to a preset height (for example, 2 m) from the second receiving unit 200 (S1102).

Here, the overall height may refer to a height between the highest and lowest points of the vehicle. In general, the overall height may be a height from the ground to an uppermost portion of the vehicle.

Air pushing toward the front of the surrounding vehicle 2 affects the driving of the driving vehicle 1, and thus, it may be understood that as the overall height increases, the air has a greater impact on the driving of the driving vehicle 1.

In a case in which the overall height of the surrounding vehicle 2 is less than or equal to a preset height (for example, 2 m), the controller 300 may confirm a first position including a first section, a second section, and a third section, through the relative position information of the surrounding vehicle 2 and the driving vehicle 1 received through the second receiving unit 200 (S1103).

Here, the first section may be a section in which the surrounding vehicle 2 begins to overlap the driving vehicle 1, the second section may be a section from a point at which a front end portion of the surrounding vehicle 2 passes through a center portion of the driving vehicle 1 to a point at which an overlapping section with the driving vehicle 1 disappears, and the third section may be a section in which a distal end portion of the surrounding vehicle 2 does not overlap the driving vehicle 1, that is, the surrounding vehicle 2 overtakes the driving vehicle 1 and deviates from the driving vehicle 1.

Here, the controller 300 may first perform divisions into the first section, the second section, and the third section, and then divides the section into detailed positions (for example, positions A to G) for each section, but the present disclosure is not limited, and the controller 300 may directly distinguish detailed positions (for example, positions A to G) based on the relative position information of the surrounding vehicle 2 and the driving vehicle 1 received through the second receiving unit 200.

In a case of division into the first section, the controller 300 may distinguish a second position including position A and position B (S1104).

Here, position A may be a position from a section in which the front end portion of the surrounding vehicle 2 begins to overlap the driving vehicle 1 to a point at which a position of the front end portion of the surrounding vehicle 2 overlapping the driving vehicle 1 is up to 5% of a length of the driving vehicle 1.

In a case in which the surrounding vehicle 2 is in position A, clockwise moment may occur in the driving vehicle 1 and lateral force pushing in an opposite direction of the surrounding vehicle 2 may increase.

Additionally, position B may be a position in which the front end portion of the surrounding vehicle 2 overlapping the driving vehicle 1 is 5 to 50% of a length of the driving vehicle 1.

When the surrounding vehicle 2 is in position B, the driving vehicle 1 may include a point at which the clockwise moment gradually decreases and disappears, and may include a maximum point of the lateral force pushing in the opposite direction of the surrounding vehicle 2.

In a case of division into position A, the controller 300 may be configured to generate a flow of air in the opposite direction of the driving vehicle 1 only to a flap 420 provided on a rear wheel of the driving vehicle, which may offset the clockwise moment and the lateral force occurring in the opposite direction of the surrounding vehicle 2 (S1105).

For example, in a case in which the surrounding vehicle 2 is in position A on the right side of the vehicle, the flap 420 provided on the front wheel may control the rotation angle to 0 (zero°) to close the opening 411, and the flap 420 provided on the left side of the rear wheel may be rotated in the second direction, and the flap 420 provided on the right side may be rotated in the first direction.

In a case of division into position B, the controller 300 may be configured to generate a flow of air through the flaps 420 provided on the front and rear wheels in the opposite direction of the driving vehicle 1, which may offset the lateral force occurring in the opposite direction of the surrounding vehicle 2 (S1106).

For example, when the surrounding vehicle 2 is in position B on the right side of the vehicle, the flap 420 provided on the left side of the front and rear wheels may be rotated in the second direction, and the flap 420 provided on the right side of the front and rear wheels may be rotated in the first direction.

In the case of division into the second section, the controller 300 may distinguish a second position including position C, position D, position E, and position F (S1107).

Here, position C may be a point at which the front end portion of the surrounding vehicle 2 passes by the center portion of the driving vehicle 1. In position C, moment in a direction opposite to that of the first section, that is, a counterclockwise moment, may occur, and lateral force pushing in the opposite direction of the surrounding vehicle 2 may occur.

Additionally, position D may be a position in which an overlapping section between the driving vehicle 1 and the surrounding vehicle 2 is disposed between 50 and 100% of a length of the driving vehicle 1, and a distal end portion of the surrounding vehicle 2 still does not overlap the driving vehicle 1.

In position D, moment may occur in the same direction as position C, that is, in the counterclockwise direction, and lateral force pushing in the opposite direction of the surrounding vehicle 2 may occur, but a magnitude thereof may decrease as the overlapping section increases.

Additionally, position E may be a position of a point at which an overlapping section between the driving vehicle 1 and the surrounding vehicle 2 is disposed between 50 and 100% of the length of the driving vehicle 1, and a distal end portion of the surrounding vehicle 2 begins to overlap the driving vehicle 1.

In position E, moment may occur in the same direction as position D, that is, in the counterclockwise direction, but a magnitude thereof may decrease as the overlapping section increases, and unlike positions A to D, lateral force pulling in a direction of the surrounding vehicle 2 may occur.

Additionally, position F may be a position in which a front end portion of the surrounding vehicle 2 has passed by the driving vehicle 1 and a distal end portion of the surrounding vehicle 2 is in an overlapping section with the driving vehicle 1.

Position F may include a point at which moment in the same direction as position E, that is, a counterclockwise moment, may occur, but a magnitude thereof may decrease as the overlapping section increases, and the magnitude may disappear.

Similarly to position F, lateral force pulling in the direction of the surrounding vehicle 2 may occur, and a maximum point of the lateral force pulling in the direction of the surrounding vehicle 2 may be included.

In a case of division into position C, the controller 300 may be configured to generate a flow of air in the opposite direction of the driving vehicle 1 only to a flap 420 provided on a front wheel of the vehicle, which may offset the counterclockwise moment and the lateral force occurring in the opposite direction of the surrounding vehicle 2 (S1108).

For example, in a case in which the surrounding vehicle 2 is in position C on the right side of the vehicle, the flap 420 provided on the left side of the front wheel may be rotated in the second direction, the flap 420 provided on the right side may be rotated in the first direction, and the flap 420 provided on the rear wheel may close the opening 411 by controlling the rotation angle to 0 (zero) °.

In a case of division into position D, the controller 300 may be configured to generate a flow of air in the opposite direction of the driving vehicle 1 only to the flap 420 provided on the front wheel, which may offset the counterclockwise moment and the lateral force occurring in the opposite direction of the surrounding vehicle 2 (S1109).

For example, in a case in which the surrounding vehicle 2 is in position D on the right side of the vehicle, the flap 420 provided on the left side of the front wheel may be rotated in the second direction, the flap 420 provided on the right side may be rotated in the first direction, and the flap 420 provided on the rear wheel may close the opening 411 by controlling the rotation angle to 0 (zero) °.

Here, referring again to FIG. 18, as the magnitude of moment and later force decreases from position C to position D, the rotation angle of the flap 420 of S1109 may be adjusted to be smaller than the rotation angle of the flap 420 of S1108.

In a case of division into E position, the controller 300 may be configured to generate a flow of air in the direction of the driving vehicle 1 only to the flap 420 provided on the rear wheel, which may offset the lateral force occurring in the direction of the surrounding vehicle 2 (S1110).

For example, in a case in which the surrounding vehicle 2 is in position E on the right side of the vehicle, the flap 420 provided on the front wheel may close the opening 411 by controlling the rotation angle to 0 (zero)°, and the flap 420 provided on the left side of the rear wheel may be rotated in the first direction, and the flap 420 provided on the right side may be rotated in the second direction.

In a case of division into position F, the controller 300 may be configured to generate a flow of air in the direction of the driving vehicle 1 on the flap 420 provided on the front and rear wheels, which may offset the counterclockwise moment and the lateral force occurring in the direction of the surrounding vehicle 2 (S1111).

For example, in a case in which the surrounding vehicle 2 is in position F on the right side of the vehicle, the flap 420 provided on the left side of the front and rear wheels may be rotated in the first direction, and the flap 420 provided on the right side of the front and rear wheels may be rotated in the second direction.

In a case of division into the third section, the controller 300 may be configured to generate a flow of air in the opposite direction of the driving vehicle 1 only to the flap 420 provided on the rear wheel, which may offset the clockwise moment and the lateral force occurring in the opposite direction of the surrounding vehicle 2 (S1112).

For example, when the surrounding vehicle 2 is in the third section at a position G on the right side of the vehicle, the flap 420 provided on the front wheel may close the opening 411 by controlling the rotation angle to 0 (zero)°, and the flap 420 provided on the left side of the rear wheel may be rotated in the second direction, and the flap 420 provided on the right side may be rotated in the first direction.

Referring to FIG. 20, when an overall height of the surrounding vehicle 2 exceeds a preset height (for example, 2 m), the controller 300 may confirm the first location including the first section, the second section, and the third section, through the relative position information of the surrounding vehicle 2 and the driving vehicle 1 received through the second receiving unit 200 (S1201).

When the overall height of the surrounding vehicle 2 exceeds a preset height (for example, 2 m), S1201 to S1210 may be the same process as S1103 to S1112.

However, when S1203, S1204, S1206, S1207, S1208, S1209, and S1210 are compared with S1105, S1106, S1108, S1109, S1110, S1111, and S1112, a position and a direction of the controlled flap 420 are the same, but a controlled rotation angle thereof may be larger.

This is because when the overall height of the vehicle is high, the influence of the driving vehicle 1 according to the position of the surrounding vehicle 2 is greater.

S1201 to S1210 may be compared with S1103 to S1112, in S1203, S1204, S1206, S1207, S1208, S1209, and S1210, the controller 300 may perform the same control except for controlling the angle of the rotation flap 420 to be larger, and thus, repetitive content may be replaced with the content described above in S1103 to S1112.

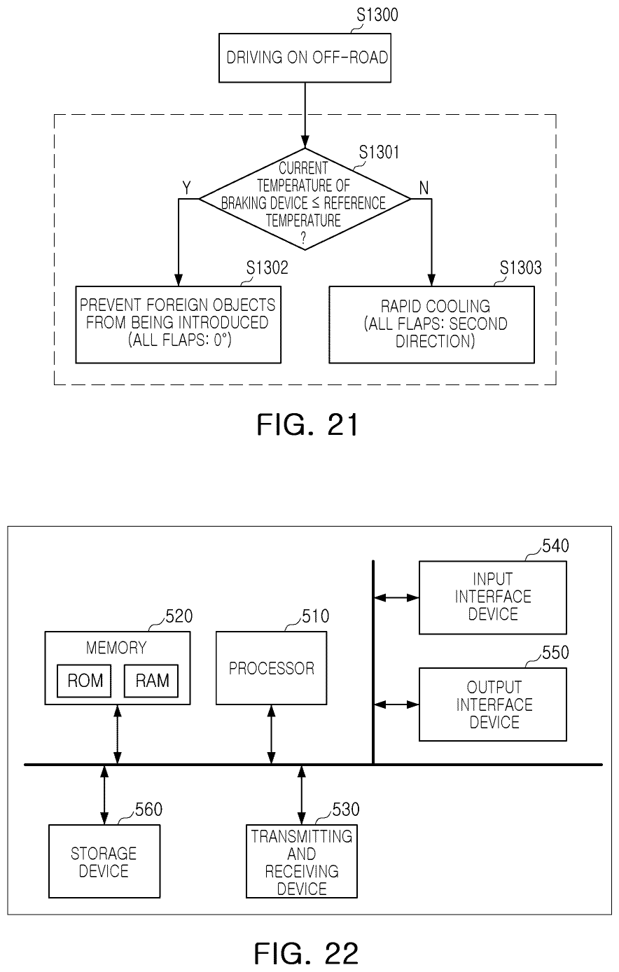

FIG. 21 is a flowchart of a control method of a variable wheel 400 according to another exemplary embodiment of the present disclosure.

Referring to FIG. 21, a controller 300 may confirm whether the vehicle drives on off road (S1300).

Here, driving on the off-road may denote driving on an unpaved road.

For example, the driving on the off-road may refer to driving in environments in which there are no roads or road markings, such as mud roads, rugged mountain roads, sandy beaches, swamps and various other unpaved terrains.

In a case of the driving on the off-road, to prevent an inflow of foreign objects (soil, dust, stones, etc.) and to protect the flap 420 of the variable wheel 400, the controller 300 may adjust the rotation angle of the flap 420 of the variable wheel 400 to 0 (zero).

The flap 420 of the variable wheel 400 may adjust the rotation angle to 0 (zero) to minimize the flow of air passing through the wheel, and foreign objects flowing in with the air may be minimized, protecting a braking device and the flap 420 of the variable wheel 400.

On the other hand, when air does not flow through the wheel, the braking device may not be cooled and may overheat. When the braking device overheats, the friction between a disk and a pad of the braking device may decrease, which may reduce braking performance or cause damage or deformation to the braking device.

Accordingly, the controller 300 may compare a current temperature of the braking device (e.g., the temperature of the brake pad) with a predetermined reference temperature (e.g., 250° C.) (S1301).

In a case in which the current temperature of the braking device (e.g., the temperature of the brake pad) is less than the predetermined reference temperature (e.g., 250° C.), the controller 300 may adjust the rotation angle of the flap 420 of the variable wheel 400 to 0 (zero), which may minimize the flow of air passing through the wheel to minimize foreign objects introduced with the air, and may protect the flap 420 of the braking device and the variable wheel 400 (S1302).

Additionally, when the current temperature of the braking device (e.g., the temperature of the brake pad) exceeds a predetermined reference temperature (e.g., 250° C.), the controller 300 may adjust the rotation angle of the flap 420 to allow air to pass through the wheel, which may prevent deterioration of the performance of the braking device by cooling the braking device, and may prevent damage or deformation (S1303).

Here, the controller 300 may open all flaps 420 of the variable wheel 400 maximally in the second direction, thus cooling the braking device rapidly by maximizing an air flow volume and flow speed.

When the flap 420 is opened in the second direction, a fan effect may occur according to the rotation of the wheel, and a passing flow rate may be maximized.

FIG. 22 is a physical block diagram of a control device for a variable wheel 400 according to an exemplary embodiment of the present disclosure.

Referring to FIG. 22, a control device for the variable wheel 400 according to an exemplary embodiment of the present disclosure may include at least one processor 510, a memory 520 storing at least one program instruction executed by the processor 510 and results of instruction execution, a flap 420 provided on at least one variable wheel 400, and a transmitting and receiving device 530 communicating with a driver 440 of the flap 420.

Additionally, the control device of the variable wheel 400 may further include an input interface 540 device, an output interface 550 device, and a storage device 560.

The components included in the control device of the variable wheel 400 may be connected by a bus and may communicate with each other.

The processor 510 may execute program instructions stored in the memory 520 or the storage device 560. The processor 510 may include a central processing unit (CPU) and a graphics processing unit (GPU), or may be another type of dedicated processor 510 suitable for performing a method according to an exemplary embodiment of the present disclosure.

The memory 520 may load program instructions stored in the storage device 560 and may provide the program instructions to the processor 510 so that the processor 510 may execute the program instructions. The memory 520 may include, for example, a volatile memory such as a Random Access Memory (RAM) and a non-volatile memory such as a Read-Only Memory (ROM).

The storage device 560 is a recording medium suitable for storing program instructions and data, and may include, for example, magnetic media such as a hard disk, a floppy disk and a magnetic tape, optical media such as CD-ROM (Compact Disk Read Only Memory) and DVD (Digital Video Disk), Magneto-Optical Media such as a Floptical Disk, a flash memory or Erasable Programmable ROM (EPROM), or semiconductor memories such as SSD manufactured based on these.

The program instructions stored in the storage device 560 may be suitable for implementing the control method of the variable wheel 400 according to an exemplary embodiment of the present disclosure.

Methods according to an exemplary embodiment of the present disclosure may be implemented in a form of program instructions which may be executed through various computer means and may be recorded on computer-readable media. The computer-readable media may include program instructions, data files, data structures, and the like, alone or in combination. The program instructions recorded on a computer-readable medium may be specially designed and constructed for the present disclosure or may be known and usable by those skilled in the computer software art.

Examples of computer-readable media include hardware devices specially configured to store and execute program instructions, such as ROM, RAM, and a flash memory. Examples of program instructions include a machine language code produced by a compiler, as well as a high-level language code which may be executed by a computer using an interpreter and the like. The above-described hardware device may be configured to operate with at least one software module to perform the operations of the present disclosure, and vice versa.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control device of a variable wheel, the control device comprising:
a receiving unit configured to receive internal driving information of a vehicle; and
a controller operatively connected to the receiving unit and configured to control a flap of the variable wheel provided on each wheel of the vehicle to rotate in a first direction or a second direction, based on the internal driving information,
wherein the controller is further configured to individually control a rotation direction or a rotation angle of the flap of the variable wheel.

2. The control device of claim 1,
wherein the first direction is a direction of rotation of the flap of the variable wheel to allow air to flow from an outside of the wheel to an inside thereof, and
wherein the second direction is a direction of rotation of the flap of the variable wheel to allow air to flow from the inside of the wheel to the outside.

3. The control device of claim 1,
wherein the internal driving information includes information on a ground clearance of the vehicle, and
wherein the controller is further configured to control the flap of the variable wheel by comparing the ground clearance with a predetermined reference ground clearance.

4. The control device of claim 3,
wherein in response that the ground clearance is lower than the reference ground clearance, and
wherein the controller is further configured to control the flap of the variable wheel to reduce air flow passing through the variable wheel.

5. The control device of claim 3,
wherein in response that the ground clearance is higher than the reference ground clearance, and
wherein the controller is further configured to control the flap to reduce air flow passing through the variable wheel provided on a front wheel of the vehicle, and to control the flap of the variable wheel provided on a rear wheel of the vehicle to rotate in the first direction.

6. The control device of claim 1,
wherein the internal driving information includes information on occurrence of understeer or oversteer of the vehicle, and
wherein in response that the understeer or the oversteer occurs, the controller is further configured to control the flap so that air flow formed by the variable wheel provided on a front wheel of the vehicle and air flow formed by the variable wheel provided on a rear wheel of the vehicle are formed in opposition to each other.

7. The control device of claim 6, wherein the controller is further configured to:
control the variable wheel provided on a right front wheel of the vehicle and the flap of the variable wheel provided on a left rear wheel of the vehicle to rotate in a same direction, and control the variable wheel provided on a left front wheel of the vehicle and the flap of the variable wheel provided on a right rear wheel of the vehicle to rotate in a same direction, and
control the variable wheel provided on the right front wheel and the flap of the variable wheel provided on the left rear wheel to rotate in different directions from the variable wheel provided on the left front wheel and the flap of the variable wheel provided on the right rear wheel.

8. The control device of claim 1,
wherein the internal driving information includes lateral acceleration information and steering angle information, and
wherein the controller is further configured to control the flap of the variable wheel by comparing the lateral acceleration with reference lateral acceleration determined based on a steering angle of the vehicle.

9. The control device of claim 8, wherein the controller is further configured to control the variable wheel so that the flap of the variable wheel provided on a left side of a front wheel and a rear wheel of the vehicle and the flap of the variable wheel provided on a right side of the front wheel and the rear wheel rotate in different directions.

10. A control device of a variable wheel, the control device comprising:
a receiving unit configured to receive external driving information of a driving vehicle; and
a controller operatively connected to the receiving unit and configured to control a flap of the variable wheel provided on each wheel of the vehicle to rotate in a first direction or a second direction, based on the external driving information,
wherein the controller is further configured to individually control a rotation direction or a rotation angle of the flap of the variable wheel.

11. The control device of claim 10,
wherein the first direction is a direction of rotation of the flap of the variable wheel to allow air to flow from an outside of the wheel to an inside thereof, and
wherein the second direction is a direction of rotation of the flap of the variable wheel to allow air to flow from the inside of the wheel to the outside.

12. The control device of claim 10,
wherein the external driving information includes relative position information of a surrounding vehicle driving close to the driving vehicle, and
wherein the controller is further configured to control the flap of the variable wheel by dividing a relative position into a plurality of sections, based on the relative position information of the surrounding vehicle.

13. The control device of claim 12, wherein the plurality of sections are distinguished according to changes in a magnitude or a direction of force and moment acting on the driving vehicle which change depending on a relative position of the driving vehicle and the surrounding vehicle.

14. The control device of claim 12, wherein in a section in which a front end portion of the surrounding vehicle begins to overlap a rear end portion of the driving vehicle, among the plurality of sections,
the controller is further configured to,
control the flap of the variable wheel provided on a rear wheel of the driving vehicle, or the flap of the variable wheel provided on front and rear wheels of the driving vehicle, and
control a flap of the variable wheel disposed close to a side of the surrounding vehicle to rotate in the first direction, and control a flap of the variable wheel disposed away from a side of the surrounding vehicle to rotate in the second direction.

15. The control device of claim 12, wherein in a section in which a front end portion of the surrounding vehicle overlaps a rear end portion of the driving vehicle, and a rear end portion of the surrounding vehicle does not overlap the rear end portion of the driving vehicle, among the plurality of sections,
the controller is further configured to:
control the flap of the variable wheel provided on a front wheel of the vehicle, and
among flaps of the variable wheel provided on the front wheel, control a flap of the variable wheel disposed close to a side of the surrounding vehicle to rotate in the first direction, and control a flap of the variable wheel disposed away from a side of the surrounding vehicle to rotate in the second direction.

16. The control device of claim 15, wherein the controller is further configured to control a rotation angle of the flap of the variable wheel to be reduced as an overlapping section between the driving vehicle and the surrounding vehicle increases.

17. The control device of claim 12, wherein in a section in which each of a front end portion and a rear end portion of the surrounding vehicles is disposed between a front end portion and a rear end portion of the driving vehicle, among the plurality of sections,
the controller is further configured to,
control the flap of the variable wheel provided on a rear wheel of the driving vehicle, and
among flaps of the variable wheel provided on the rear wheel, control a flap disposed close to a side of the surrounding vehicle to rotate in the second direction, and control a flap disposed away from a side of the surrounding vehicle to rotate in the first direction.

18. The control device of claim 12, wherein in a section in which a front end portion of the surrounding vehicle passes by a front end portion of the driving vehicle, and a rear end portion of the surrounding vehicle is disposed between a front end portion and a rear end portion of the driving vehicle, among the plurality of sections,
the controller is further configured to,
control the flaps of the variable wheel provided on a front wheel and a rear wheel, and
among flaps of the variable wheel provided on the front wheel and the rear wheel, control the flap disposed close to a side of the surrounding vehicle to rotate in a second direction, and control the flap disposed away from the surrounding vehicle to rotate in the first direction.

19. The control device of claim 12, wherein in a section after a rear end portion of the surrounding vehicle passes by a front end portion of the driving vehicle, among the plurality of sections,
the controller is further configured to:
control the flap of the variable wheel provided on a rear wheel of the driving vehicle, and
among flaps of the variable wheel provided on the rear wheel, control a flap disposed close to a side of the surrounding vehicle to rotate in the first direction, and control a flap disposed away from a side of the surrounding vehicle to rotate in the second direction.

20. The control device of claim 10,
wherein the external driving information includes information on an overall height of a surrounding vehicle driving close to the driving vehicle, and
wherein the controller is further configured to control the rotation angle of the flap of the variable wheel to be increased as the overall height of the surrounding vehicle is higher.

21. A control device of a variable wheel, the control device comprising:
a receiving unit configured to receive temperature information of a braking device; and
a controller operatively connected to the receiving unit and configured to control a flap of the variable wheel to open or close an opening of the variable wheel provided to allow air to pass through a wheel, based on the temperature information of the braking device.

22. The control device of claim 21, wherein the controller is further configured to control the flap of the variable wheel to close the opening of the variable wheel in response that a vehicle drives off road.

23. The control device of claim 21, wherein in response that a temperature of the braking device exceeds a predetermined reference temperature,
the controller is further configured to control the flap of the variable wheel to open an opening of the variable wheel provided to allow air to pass through the wheel.

24. The control device of claim 23, wherein the controller is further configured to control the flap of the variable wheel so that the air passes from an inside to an outside of the wheel.
